(19) United States
(12) Patent Application Publication
(10) Pub. No.: US 2005/0200650 A1
(43) Pub. Date: Sep. 15, 2005

(54) Ink jet type recording device

(75) Inventors: Hidehiko Inokuchi, Fukuoka (JP); Masaharu Tanaka, Fukuoka (JP); Hiroyuki Ogata, Fukuoka (JP); Kenji Kanabo, Fukuoka (JP); Yutaka Miyazono, Fukuoka (JP)

Correspondence Address: HARNESS, DICKEY & PIERCE, P.L.C., P.O. BOX 828, BLOOMFIELD HILLS, MI, 48303, US

(73) Assignee: Matsusita Electric Industrial Co., LTD., Osaka (JP)

(21) Appl. No.: 10/522,100

(22) PCT Filed: May 20, 2004
(86) PCT No.: PCT/JP04/07241

§ 371 Date: Jan. 24, 2005

(30) Foreign Application Priority Data
May 22, 2003 (JP) 2003-145460
May 22, 2003 (JP) 2003-145462

(51) Int. Cl. B41J 23/00

(52) U.S. Cl. 347/37

(57) ABSTRACT

A printer 1 is provided with a thin casing 10. Inside of this casing 10, a power supply substrate 500 is arranged above a disk tray 300 supporting a disk as a recording medium on which recording is performed by a recording head 101. Furthermore, a purge unit 400 purging ink of the recording head 101 is provided, and an ink container 435 of a first ink collector 430 which collects the ink after purge of this purge unit 400 is arranged on a lateral side of a conveying route of a recording paper 50 as the recording medium on which recording is performed by the recording head 101.

### FIELD OF THE INVENTION

The present invention belongs to a technical field relating to an ink-jet recording device provided with a substantially rectangular parallelepiped casing whose vertical length is shorter than lateral and anteroposterior directions thereof.

### BACKGROUND ART

Conventionally, a recording device provided with an ink-jet recording head has often been used as a printer for personal computer or the like, for example. However, a conventional printer commonly used has required enough space as a setting place. In particular, it can be set only in a place where enough space is secured above a setting surface such as a personal computer rack. From now on, the application target of a printer will not be limited to a personal computer or the like, but be expanded to a wider range including a television, a video and the like, for example.

Consequently, there is proposed a thin printer in order to enable setting in a setting place above which there is not enough space such as a television rack and an audio rack (for example, refer to Japanese Patent Applications Laid-Open No. 2001-191613 and No. 2001-213019). This type of printer is structured such that a substantially rectangular parallelepiped casing having a shape and dimensions corresponding to the audio equipment or the like is provided and such that a paper feed tray or the like can be operated from the front side of a casing by an operator.

However, since the conventional thin printer is structured such that the casing is merely made thin, it is hard to say that sufficient ingenuity has been exercised for arrangement of a power source substrate and a control substrate, or the like. Therefore, although the printer can be housed in an audio rack or the like, it has been hard to say that reliability is sufficient in view of influence of heat generation by the power supply substrate or the like.

Furthermore, in an ink-jet recording head, if dry ink is left in a nozzle, an ink discharging performance is deteriorated. Accordingly, the recording device is provided with a purge unit forcibly discharging ink in the nozzle, and by performing a so-called purge operation of forcibly discharging the ink inside the nozzle in the purge unit at non-recording time, the performance of the recording head is maintained, and by causing the ink after purge to be absorbed in an absorber, the ink is prevented from leaking outside.

By the way, in the recording device provided with the purge unit, considering long-term use, since the amount of ink purged from the recording head is never small, an absorber thereof requires a size or a capacity capable of absorbing a certain amount of ink. In the conventional printer, therefore, a large volume of absorber is provided in a bottom part of the casing to make the absorber absorb the ink after purge.

However, when the large volume of absorber is arranged in the bottom part of the casing, a certain setting space in the casing bottom part is required, which increases a height of the device. Therefore, a further reduction in thickness of the device has been difficult. On the other hand, if the capacity of the absorber is decreased to reduce the thickness, there is a possibility that ink leakage occurs, thereby causing a problem with reliability.

The present invention is made in light of the above-mentioned points, and its object is to reduce the thickness of the device while increasing the reliability in the recording device provided with a substantially rectangular parallelepiped casing as described above.

### DISCLOSURE OF THE INVENTION

An ink-jet recording device according to the present invention comprises a substantially rectangular parallelepiped casing whose vertical length is shorter than lateral and anteroposterior lengths thereof, an ink-jet recording head provided inside of the casing, a tray which is arranged under the recording head inside of the casing and supports a recording medium on which recording is performed by the recording head, a moving mechanism moving the tray in the casing anteroposterior direction so that the tray passes through a position under the recording head, and a power supply substrate arranged above the tray inside of the casing.

According to the recording device, since the power supply substrate is arranged above the tray, heat of the power supply substrate is hardly transmitted to the tray. Therefore, the tray is hardly affected by the heat of the power supply substrate. Accordingly, adverse influence by the heat generation of the power supply substrate generated with a reduction in thickness (for example, thermal deformation of the tray) can be inhibited, thereby improving reliability of the device. Furthermore, an empty space above the tray is effectively used as a setting space of the power supply substrate, thereby promoting a reduction in thickness of the device.

Furthermore, another ink-jet recording device according to the present invention comprises a substantially rectangular parallelepiped casing whose vertical length is shorter than lateral and anteroposterior lengths thereof, a carriage shaft extending in the casing lateral direction inside of the casing, a carriage which reciprocates along the carriage shaft in the casing lateral direction, an ink-jet recording head attached to the carriage, a conveying mechanism conveying a recording medium in a direction perpendicular to the carriage shaft during recording operation onto the recording medium by the recording head to lead the recording medium to a recording position where the recording is performed by the recording head, a purge unit which is provided on one end side of the carriage shaft and purges ink of the recording head, and a first ink collector which has an ink container set on the lateral side of a conveying route of the recording medium inside of the casing and collects the ink after purge of the purge unit in the ink container.

According to the recording device, since the ink container of the first ink collector is provided on the lateral side of the conveying route of the recording medium, the ink container can be set inside of the casing so that a height (vertical length) thereof is substantially the same as the height of the casing. Accordingly, a large amount of ink is stored inside of the ink container to thereby secure a sufficient amount of collected ink, so that a reduction in thickness of the device can be accomplished while improving reliability.

### BRIEF DESCRIPTION OF THE DRAWINGS

FIG. 1 is a front perspective view showing an appearance of a printer according to Embodiment 1 of the present invention.

FIG. 2 is a rear perspective view of the printer.

FIG. 3 is a front perspective view showing an internal structure of the printer.

FIG. 4 is a side elevational view of the inside of the printer.

FIG. 5 is a front perspective view showing the internal structure of the printer (a view showing a part hidden by a right side frame by removing the right side frame from FIG. 3).

FIG. 6 is a cross-sectional view showing a purge unit and a first ink collector in the printer.

FIG. 7 is a cross-sectional view showing a second ink collector in the printer.

FIG. 8 is a perspective view showing a control substrate in the printer.

FIG. 9 is a plane view of the printer.

FIG. 10 is a view equivalent to FIG. 8 which shows a modification of the control substrate.

FIG. 11 is a view equivalent to FIG. 5 which shows a modification of a connection point of a tube with respect to an ink container of the first ink collector.

FIG. 12 is a view equivalent to FIG. 6 which corresponds to the modification of FIG. 11.

FIG. 13 is a view equivalent to FIG. 6 which shows a further modification of the connection point of the tube with respect to the ink container of the first ink collector.

FIG. 14 is a view equivalent to FIG. 5 which shows a modification of the first ink collector.

FIG. 15 is a view equivalent to FIG. 3 which shows a modification of a case where a heater is provided in the vicinity of a fan.

FIG. 16 is a view equivalent to FIG. 3 which shows an internal structure of a printer according to Embodiment 2.

FIG. 17 is a cross-sectional view showing a purge unit and a platen in the printer according to Embodiment 2.

FIG. 18 is a view equivalent to FIG. 5 which shows an internal structure of a printer according to Embodiment 3.

FIG. 19 is a view equivalent to FIG. 5 which shows an internal structure of a printer according to Embodiment 4.

FIG. 20 is a perspective view showing an absorber cartridge in the printer according to Embodiment 4.

FIG. 21 is a cross-sectional view of the absorber cartridge.

FIG. 22 is a cross-sectional view showing a state in which an ink discharging needle is inserted into an ink introducing mechanism of the absorber cartridge.

FIG. 23 is a view equivalent to FIG. 1 which shows an appearance of the printer according to Embodiment 4.

FIG. 24 is a view equivalent to FIG. 1 which shows a state in which the absorber cartridge is replaced through an entrance by opening a lid in the printer according to Embodiment 4.

### BEST MODE FOR CARRYING OUT THE INVENTION

### Embodiment 1

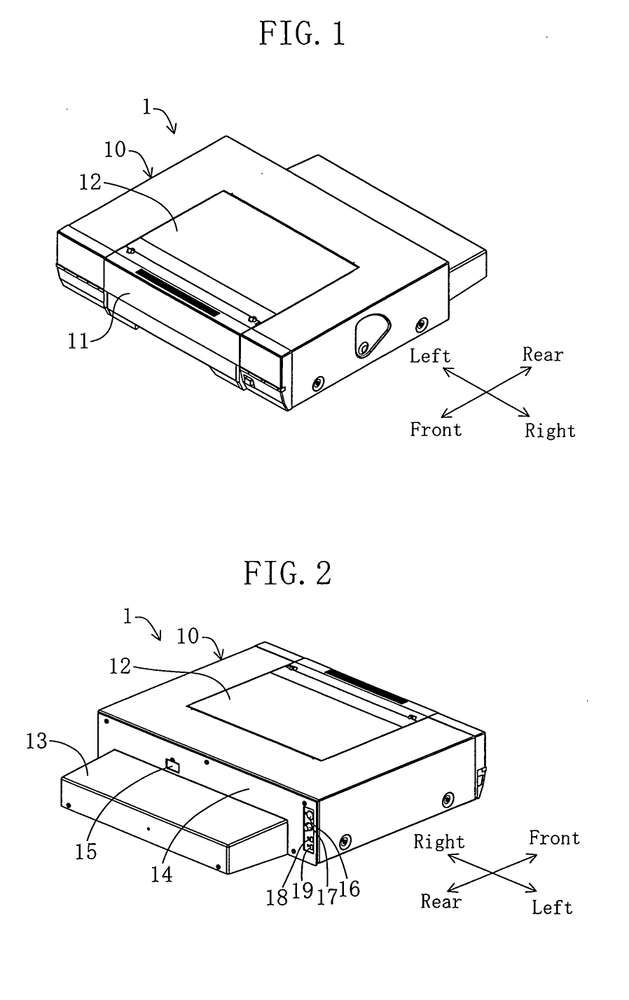

FIG. 1 shows an appearance of a printer 1 as an ink-jet recording device according to Embodiment 1 of the present invention. This printer 1 is of a thin type easy to house in an audio rack or the like. More specifically, a casing 10 of this printer 1 is a thin casing, and is formed into a substantially rectangular parallelepiped shape whose vertical length (height) is shorter than lateral and anteroposterior lengths thereof. Here, the height is set to not more than ¼ the lateral length and not more than ⅓ the anteroposterior length. In a part from a front surface to an upper surface in a central part in the lateral direction of the casing 10, an opening for feeding and discharging paper, replacing an ink cartridge or the like is formed, and in the front surface and the upper surface of the casing 10, there are provided a front lid 11 and an upper lid 12 covering the opening so as to be freely opened and closed, respectively. The left and right of the casing 10 denote the left and right as seen from the front surface of the casing 10, respectively.

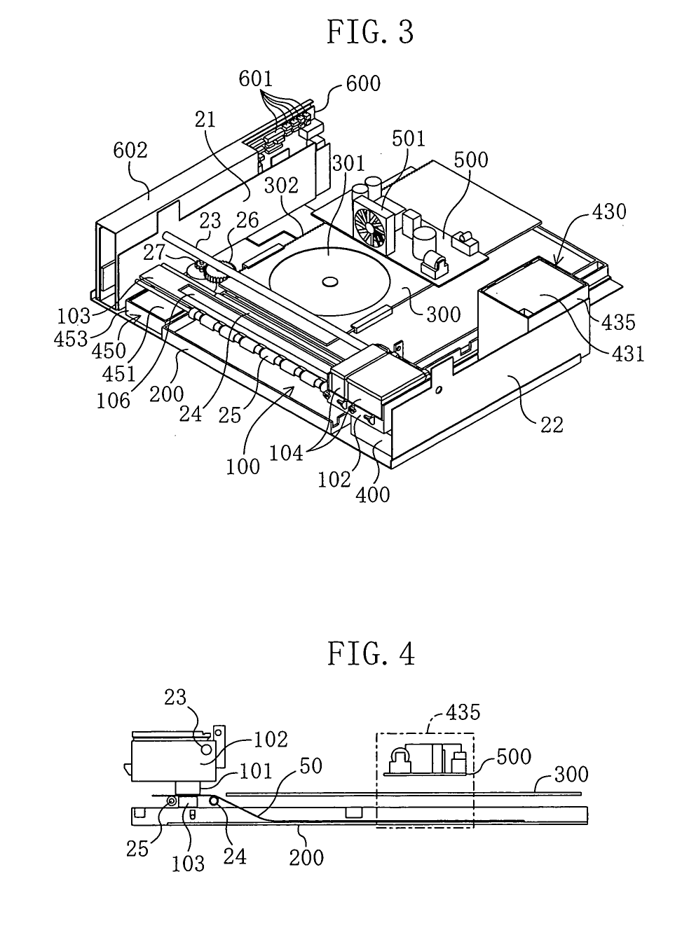

As shown in FIG. 2, a protruded part 13 protruding rearward is formed in a back surface 14 (rear surface) of the casing 10. As described later, this protruded part 13 covers rear ends of a paper feed cassette 200 and a disk tray 300 (refer to FIGS. 3 and 4) extending rearward beyond a rear end of a side surface of the casing 10.

In the back surface 14 of the casing 10, a plurality of external connection terminals 15 to 19 are arranged. More specifically, the plug-in 15 of a power supply cable and the other external connection terminals 16 to 19 are provided in a part other than the protruded part 13 in the back surface 14. In the back surface 14 of the casing 10, openings for exposing these external connection terminals 15 to 19 (openings for connection to the external connection terminals 15 to 19) are formed, and the external connection terminals 15 to 19 are exposed to the outside of the casing 10 through these openings. The external connection terminals 16 to 19 are terminals for connecting the printer 1 and other equipment, and for example, are a terminal for signal line of a television or a video cartridge recorder, a terminal for computer, a terminal for network and the like. As described later, the external connection terminals 16 to 19 are terminals provided in a control substrate 600 and are arranged in line vertically.

Next, an internal structure of the printer 1 is described. As shown in FIG. 3, inside of the casing 10, a recording part 100, the paper feed cassette 200 (supply cassette) housing recording paper 50 (refer to FIG. 4) as a recording medium on which recording is performed by a recording head 101 (refer to FIG. 4) described later in the recording part 100, the disk tray 300 supporting a disk (for example, CD, DVD or the like) which is a recording medium different from this recording paper 50, a purge unit 400, a first ink collector 430, a second ink collector 450, a power supply substrate 500, and the control substrate 600 are provided.

The recording part 100 is provided with the ink-jet recording head 101 (refer to FIG. 4), an ink tank 104, and a carriage 102 mounting and holding the recording head 101 and the ink tank 104, and a platen 103 provided so as to be opposed to the recording head 101. A position between this recording head 101 and the platen 103, that is, a position under the recording head 101 and above the platen 103 is a recording position where the recording paper 50 is recorded on by the recording head 101. In addition, the platen 103 plays the role of supporting the recording paper 50 at this recording position. The disk supported by the disk tray 300 is also recorded on at the position between the recording head 101 and the platen 103 (as described later, the disk tray 300 moves so that the disk tray 300 passes through the position under the recording head 101).

At end parts on both the left and right sides inside of the casing 10, left and right side frames 21 and 22 extending in the casing anteroposterior direction are provided, respectively. A carriage shaft 23 extending in the casing lateral direction is fixed to parts on the casing front side of both the side frames 21 and 22. The carriage 102 is structured to reciprocate along the carriage shaft 23 by a driving mechanism not shown in a state of being supported by the carriage shaft 23. Any one of end parts of this carriage shaft 23 (here, an end part on the casing right side) is a home position of the recording head 101 and the carriage 102. This home position is a position where the recording head 101 and the carriage 102 stand by at non-recording time.

The side frames 21 and 22 form a chassis supporting the carriage shaft 23. More specifically, in the present specification, the chassis means a member which is a base fixing a power supply source such as a motor, a member which is a base supporting power transmission means such as gear, pulley and roller, or a member which is a base supporting a driven member such as a carriage.

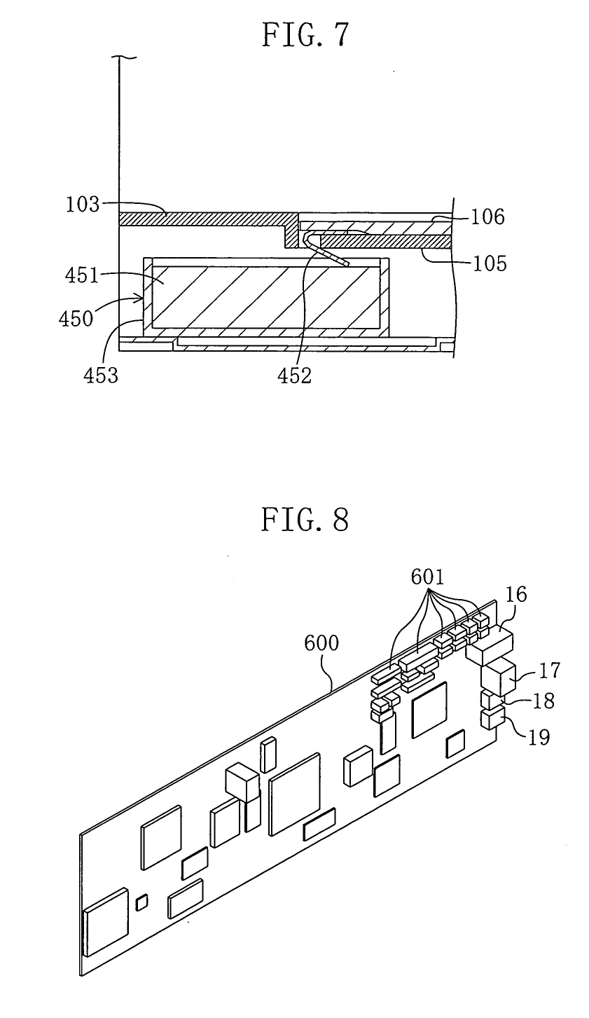

A depression 105 (refer to FIG. 7) is formed in a central part of the platen 103, and a sponge 106 is provided in this depression 105. This sponge 106 makes up an absorbing body absorbing ink, which absorbs excessive ink which has not been absorbed in the recording paper 50 in so-called frameless printing or the like.

As shown in FIG. 4, a conveying roller 24 is provided on the casing rear side of the platen 103 and a paper discharging roller 25 is provided on the casing front side of the platen 103. These conveying roller 24 and the paper discharging roller 25 convey in a direction perpendicular to the carriage shaft 23 the recording paper 50 taken out from the paper feed cassette 200 by a pick-up roller not shown. The conveying roller 24 leads the recording paper 50 to the position between the recording head 101 and the platen 103 (recording position), and the paper discharging roller 25 discharges the recording paper 50 on which recording has been performed by the recording head 101 to the front side of the casing 10.

The paper feed cassette 200 is arranged in a bottom part inside of the casing 10 and is mounted detachably with respect to the casing 10. A lateral width (a length in the casing lateral direction) of the paper feed cassette 200 is shorter than the lateral length of the casing 10. Accordingly, a certain amount of empty space is formed on each of the lateral sides of the paper feed cassette 200 inside of the casing 10. Furthermore, a length in the casing anteroposterior direction of the paper feed cassette 200 is longer than the anteroposterior length of both lateral side surfaces of the casing 10. When the paper feed cassette 200 is mounted, a rear end part of the paper feed cassette 200 extends rearward beyond the rear ends of both the side surfaces of the casing 10 and is covered with the protruded part 13 on the back surface 14 of the casing 10, as described above. By forming the protruded part 13 in this manner, both the lateral side surfaces of the casing 10 do not need to be extended to the same extent as the paper feed cassette 200, so that the casing 10 can be miniaturized as much as possible.

The disk tray 300 is arranged above the paper feed cassette 200. That is, the paper feed cassette 200 is arranged under the disk tray 300. Furthermore, the disk tray 300 is arranged under the recording head 101 and above the platen 103. Although according to the present embodiment, the disk tray 300 is formed of plastic, a material of the disk tray 300 is not particularly limited. In addition, in a part on the casing front side of the disk tray 300, a recessed part 301 into which the disk is fitted is formed. That is, the disk tray 300 supports the disk in the recessed part 301. Furthermore, in an end surface on the casing left side of the disk tray 300, a saw-like tooth 302 is formed. The saw-tooth 302 is coupled to a gear motor 27 via a gear 26, and following the rotation of the gear motor 27, the disk tray 300 goes straight and moves substantially horizontally in the casing anteroposterior direction so as to pass through the position under the recording head 101 and above the platen 103.

The purge unit 400 has an ink sucking mechanism made of a retractable pump or the like, which is omitted in the figure, and ink is sucked from the recording head 101 by the ink sucking mechanism to be removed (purged). This purge unit 400 is arranged on the right side in the casing 10, more particularly, under the recording head 101 located at the home position. Furthermore, the purge unit 400 is arranged outside of the paper feed cassette 200 and the disk tray 300 in the casing lateral direction (on the casing right side).

The first ink collector 430 has an ink container 435 and a sponge 431 as an absorbing body which is housed in the ink container 435 to collect the ink after purge of the purge unit 400 in the ink container 435. According to the present embodiment, the ink container 435 is formed into a boxy body extending in the vertical direction and opened at an upper side thereof.

The ink container 435 of the first ink collector 430 is arranged on the casing rear side of the purge unit 400. Accordingly, the ink container 435 of the first ink collector 430 is, similar to the purge unit 400, arranged outside of the paper feed cassette 200 and the disk tray 300 in the casing lateral direction (on the casing right side). That is, the ink container 435 of the first ink collector 430 is arranged on a lateral side of the conveying route of the recording medium (the recording paper 50) (on the right lateral side of the casing). Furthermore, the first ink collector 430 is designed not to be under the platen 103. Thus, in the printer 1, the first ink collector 430 is set not to be under the conveying route of the recording medium.

The whole of the ink container 435 of the first ink collector 430 may be set outside of the conveying route of the recording medium in the casing lateral direction, while as shown in FIG. 14, the ink container 435 may be set so that a part (in particular, an upper part) thereof is placed inside of the conveying route.

As shown in FIGS. 4 and 6, the ink container 435 of the first ink collector 430 extends from a lower position than a recording surface S1 (an upper surface) of the recording paper 50 located at the recording position to a higher position than the recording surface. In other words, a lower end surface of the ink container 435 is located at the lower position than the recording surface S1 of the recording paper 50 on the platen 103 between the conveying roller 24 and the paper discharging roller 25 and an upper end surface thereof is located at the higher position than the recording surface S1. Furthermore, the ink container 435 has almost the same height as the height of the casing 10. The ink container 435 may be formed of a cubic shaped container, may be formed of a rectangular parallelepiped container, and the shape is not limited. A shape in which a height is longer than a lateral length, that is, a vertically long shape may be employed.

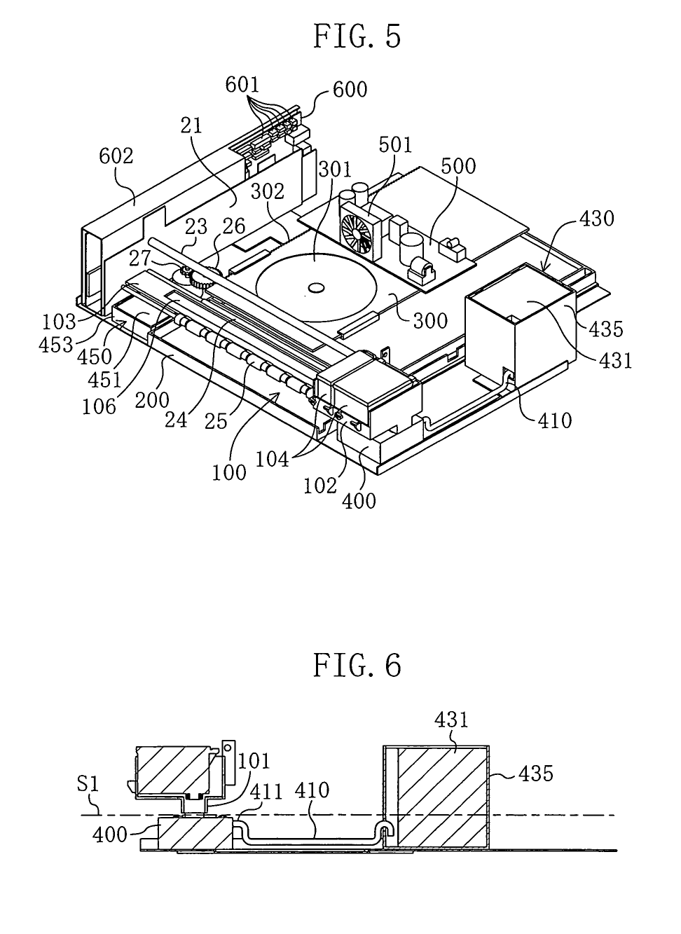

As shown in FIGS. 5 and 6, the ink container 435 is connected to the purge unit 400 via a tube 410 as an ink flow path. One end of this tube 410 is connected to an intermediate part in the vertical direction of the ink container 435, by which the tube 410 is structured so as to supply the ink to the intermediate part in the vertical direction inside of the ink container 435. More specifically, the tube 410 is connected between the recording surface S1 of the recording paper 50 located at the recording position (refer to FIG. 6) and a lowest part (the lower end surface) of the ink container 435. Furthermore, although, here, the connection point between the tube 410 and the ink container 435 is set to be located on the same level as a connection part 411 between the tube 410 and the purge unit 400, the connection point between the tube 410 and the ink container 435 may be set to a lower position than the connection point between the tube 410 and the purge unit 400. The whole tube 410 excluding the connection part 411 is preferably located at the lower level than the connection part 411.

The second ink collector 450, as shown in FIGS. 5 and 7, has a boxy ink container 453 opened on an upper side thereof and a sponge 451 as an absorbing body which is housed inside of this ink container 453, and is intended to collect in the ink container 453 excessive ink discharged from the recording head 101 and absorbed in the sponge 106 on the platen 103 in so-called frameless printing or the like. The ink container 453 of this second ink collector 450 is set on the opposite side of the purge unit 400 and the ink container 435 of the first ink collector 430 in the casing lateral direction, that is, on the left side in the casing 10, more particularly, under an end part on the casing left side of the platen 103 and between the left side frame 1 and the paper feed cassette 200 (outside of the paper feed cassette 200 and the disk tray 300 in the casing lateral direction (on the casing right side)).

As shown in FIG. 7, a felt 452 is provided between the sponge 106 on the platen 103 and the sponge 451 inside of the ink container 453. One end part of this felt 452 is in contact with the sponge 106, and the other end part is in contact with the sponge 451. This felt 452 conveys the ink from the sponge 106 to the sponge 451 with a capillary force used as a conveying drive force. That is, the felt 452 makes up ink collecting means for collecting the ink absorbed in the sponge 106 on the platen 103 into the sponge 451 of the second ink collector 450.

The power supply substrate 500 is a printed board in which a power supply circuit for driving the printer 1 is formed and is connected to the plug-in 15 of the power supply cable. This power supply substrate 500 has a cooling fan 501 attached, as shown in FIG. 3. In this printer 1, a comparatively wide empty space is formed above the disk tray 300 and the power supply substrate 500 is arranged in the empty space. That is, the power supply substrate 500 is set above the disk tray 300 and is arranged on the same side (upper side) as the recording head 101 and the carriage 102 with the respect to the disk tray 300.

The power supply substrate 500 is set in a traverse posture (posture extending in the horizontal direction). The fan 501 is provided vertically on the power supply substrate 500 so as to send air in the horizontal direction. The fan 501 is attached to an end part on the casing front side of the power supply substrate 500 and is arranged at the nearest position to the recessed part 301 of the disk tray 300. This is intended to allow the fan 501 to cool the power supply substrate 500 and to supply warm wind to the disk from the fan 501 after recording on the disk on the disk tray 300 so as to promote drying of the ink. However, the attaching position of the fan 501 is not particularly limited.

The control substrate 600 is a printed board in which a control circuit controlling the printer 1 is provided. This control substrate 600 is provided vertically in the direction perpendicular to the carriage shaft 23 in a substrate block 602 provided between the left side frame 21 (chassis on the opposite side of the home position) and the left side surface of the casing 10. Accordingly, the control substrate 600 is arranged at a position outside of the left side frame 21 in the casing lateral direction (on the casing left side). The control substrate 600 is an elongate substrate in the casing anteroposterior direction and has almost the same height and length as the left side surface of the casing 10. That is, the control substrate 600 has almost the same shape and dimensions as the left side surface of the casing 10 as viewed from the casing lateral direction.

As shown in FIG. 8, the external connection terminals 16 to 19 are arranged in line vertically in an end part on the casing rear side of the control substrate 600. These external connection terminals 16 to 19 are provided so as to be oriented to the casing rear side. Furthermore, in an upper end part on the casing rear side in an inner (the center side in the casing lateral direction (here, the casing right side)) surface of the control substrate 600 in the casing lateral direction, a plurality of internal connection terminals 601 connected to equipment inside of the casing 10 via signal lines are collectively arranged. These internal connection terminals 601 are connected to the recording head 101, the gear motor 27, the power supply substrate 500, the purge unit 400, a drive mechanism and a sensor which are not shown in the figure, and the like. The internal connection terminals 601 are provided so as to be oriented inward in the casing lateral direction. This makes it easy to attach and remove the cables, an optional substrate, or the like. As shown in FIG. 3, a part of the substrate block 602 corresponding to the internal connection terminals 601 has a notched shape so that the internal connection terminals 601 are exposed.

In the case where recording is performed on the recording paper 50 in the paper feed cassette 200, the recording paper 50 in the paper feed cassette 200 is taken out by the pick-up roller and this taken recording paper 50 is conveyed to the position between the recording head 101 and the platen 103 in the recording part 100 by the conveying roller 24. Then, the recording head 101 discharges the ink while moving in the casing lateral direction with the movement of the carriage 102 to perform the recording on the recording paper 50 on the platen 103. This recording paper 50 after recording is conveyed by the paper discharging roller 25 to be discharged from the front side of the casing 10.

In the case where printing (recording) is performed on the disk, the disk tray 300 is first protruded to the front side of the casing 10 according to the rotation of the gear motor 27. A user loads the disk on the recessed part 301 of the disk tray 300 in front of the casing 10. Thereafter, the disk tray 300 is drawn back to the rear side once, and the disk tray 300 gradually moves forward with the start of the recording operation to be located under the recording head 101. At this time, the recording head 101 discharges the ink while moving in the casing lateral direction to perform the recording on the disk on the disk tray 300. After finishing this recording, the disk tray 300 is again drawn back to the rear side to dry the disk by the fan 501, and thereafter, the disk tray 300 is protruded to the front side of the casing 10. Alternatively, immediately after finishing the recording, the disk tray 300 may be moved forward to be protruded to the front side of the casing 10. Then, in the state in which the disk tray 300 is protruded to the front side of the casing, the user removes the disk after recording from the recessed part 301 of the disk tray 300. Thereafter, the disk tray 300 is withdrawn to be housed in the casing 10.

Accordingly, according to the present printer 1, since the power supply substrate 500 is arranged above the disk tray 300, the disk tray 300 is not heated from beneath by the power supply substrate 500 and thus, the heat of the power supply substrate 500 is hardly transmitted to the disk tray 300. Therefore, there is less possibility that there arises such a problem that the disk tray 300 is deformed by the heat of the power supply substrate 500, so that adverse influence by the heat generation of the power supply substrate 500 can be inhibited. Therefore, the reliability of the printer 1 is improved.

Furthermore, since the empty space above the disk tray 300 can be effectively used, a reduction in thickness of the printer 1 can be promoted.

Furthermore, according to the present printer 1, since the control substrate 600 is provided vertically along the left side surface of the casing 10, a setting space for the substrate 600 can be reduced, so that miniaturization of the device can be promoted.

Furthermore, the control substrate 600 is provided on the opposite side of the home position of the recording head 101 and the carriage 102, so that even if the ink leaks from the recording head 101 and the purge unit 400, there is no possibility that the ink falls on the control substrate 600. Therefore, the reliability of the control substrate 600 is improved. Furthermore, since the control substrate 600 is provided on the opposite side of the home position, weight balance of the whole device is improved, thereby stabilizing the device.

In addition, since the control substrate 600 is provided outside of the left side frame 21 in the casing lateral direction inside of the casing 10, it is easy to replace or repair the control substrate 600.

Moreover, since the internal connection terminals 601 of the control substrate 600 are arranged in the upper part of the control substrate 600, it is easy to attach and remove the cables, the optional substrate and the like. It is also easy to confirm a state in which the cables, the optional substrate and the like are attached to the internal connection terminals 601. Furthermore, since the internal connection terminals 601 is formed so as to be oriented inward, the cables, the optional substrate and the like can be easily attached and removed without removing the control substrate 600.

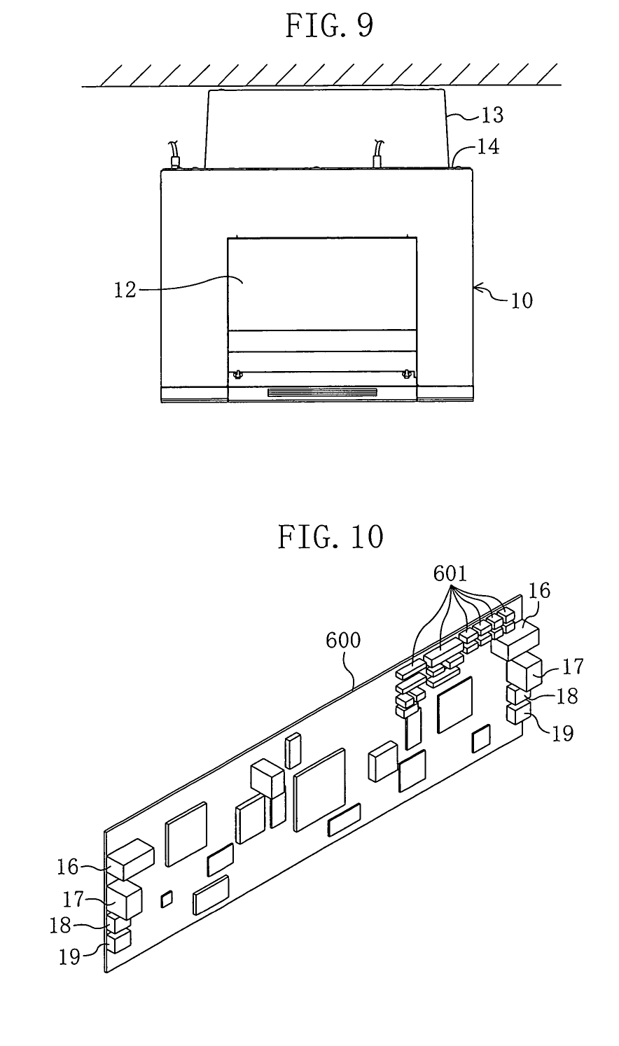

Still further, according to the present printer 1, the plug-in 15 of the power supply cable and the other external connection terminals 16 to 19 are provided in a part other than the protruded part 13 in the casing back surface 14, so that as shown in FIG. 9, even if the printer 1 is set so that the protruded part 13 is close to the vicinity of a wall surface on the casing rear side, the power supply cable and the cables connected to the external connection terminals 16 to 19 do not become hindrances and failure or loose connection of the cables hardly occur. In addition, the power supply cable and the other cables can be attached or removed with the printer 1 set in the vicinity of the wall surface. Furthermore, the external connection terminals 16 to 19 are arranged in line vertically, which makes the attachment or removal of the cables easier.

Furthermore, in the present printer 1, since the fan 501 is provided in the power supply substrate 500 and drying of the disk is promoted by the fan 501, drying time of the disk can be shortened. Furthermore, instead of providing a fan only for drying the disk, the cooling of the power supply substrate 500 and the drying of the disk are performed by the fan 501, so that the positive use of the heat of the power supply substrate 500 can promote the drying of the disk, and can reduce the fan in number.

Moreover, in the present printer 1, the ink container 435 of the first ink collector 430 collecting the ink after purge is arranged on the lateral side of the conveying route of the recording paper 50 and is not under this conveying route, so that by extending the ink container 435 from a lower position than the recording paper 50 being conveyed to a higher position than the recording paper 50, the vertical length can be comparatively large, and thus more ink can be collected in less setting area. Furthermore, although the vertical length is comparatively large, the ink container 435 can be set inside of the thin casing 10 and can be replaced easily.

The ink after purge of the purge unit 400 is introduced to the intermediate part in the vertical direction of the ink container 435 of the first ink collector 430, so that since there is no head difference of the ink, the conveying of the ink from the purge unit 400 is easy. Furthermore, by housing the sponge 431 inside of the ink container 435 in combination, a back flow from the first ink collector 430 hardly occurs. Accordingly, improvement in conveying easiness of the ink and back flow prevention can be realized in a balanced manner. Furthermore, since a part from the bottom part of the ink container 435 to the part on the upper side to which the tube 410 is connected is boxy and has no opening part, the ink leakage from the first ink collector 430 hardly occurs. Moreover, since the first ink collector 430 is arranged on the casing rear side of the purge unit 400, the purge unit 400 and the first ink collector 430 line up in the anteroposterior direction, and thus the connection between them by the tube 410 is easy and miniaturization of the device can be attained.

Furthermore, in the present printer 1, the second ink collector 450 collecting the ink absorbed in the sponge 106 on the platen 103 is provided apart from the first ink collector 430, so that the distributed arrangement of the ink collectors can miniaturize each of the first ink collector 430 and the second ink collector 450. Accordingly, a reduction in thickness of the device can be promoted. Furthermore, design freedom is enlarged and the space inside of the casing 10 is effectively used, so that miniaturization of the device can be accomplished.

In the present embodiment, although the external connection terminals 16 to 19 are provided only in the back surface 14 of the casing 10, a part or all of the external connection terminals 16 to 19 may be provided in the front surface of the casing 10. For example, as shown in FIG. 10, the control substrate 600 may be provided with the external connection terminals 16 to 19 in both the end part on the casing front side and the end part on the rear side, respectively. That is, the plurality of external connection terminals 16 to 19 may be provided in both the end part on the casing front side and the end part on the rear side of the control substrate 600 so as to line up in the vertical direction, respectively, and in this case, openings for connection to the external connection terminals 16 to 19 in the end part on the casing front side and the end part on the rear side of the control substrate 600 (openings exposing the external connection terminals 16 to 19 to the outside of the casing 10) are formed in the front surface and the back surface 14 of the casing 10, respectively. Thus, by providing the terminals in both the front surface and the back surface 14 of the casing 10, the external connection terminals of the control substrate 600 can be increased in number. To put it in other way around, the height of the control substrate 600 can be reduced while securing the number of the external connection terminals, which can promote a reduction in thickness of the device.

Furthermore, the external connection terminal to which a cable often pulled and put in (for example, a connection cable of a digital camera or the like) is connected is arranged in the front surface, and the external connection terminal to which a cable in which frequency of pulling and putting in is comparatively less (for example, a connection cable of a television or the like) is connected is arranged in the back surface 14 of the casing 10, so that the appearance from the front side can be improved and the handlability can be improved.

Furthermore, in the present embodiment, although the tube 410 connecting the purge unit 400 and the ink container 435 of the first ink collector 430 is connected to the intermediate part in the vertical direction of the ink container 435, the connection point of the tube 410 to this ink container 435 is not limited to the intermediate part in the vertical direction of the ink container 435, but can be set arbitrarily according to characteristics of the absorbing body inside of the ink container 435 of the first ink collector 430, or the like.

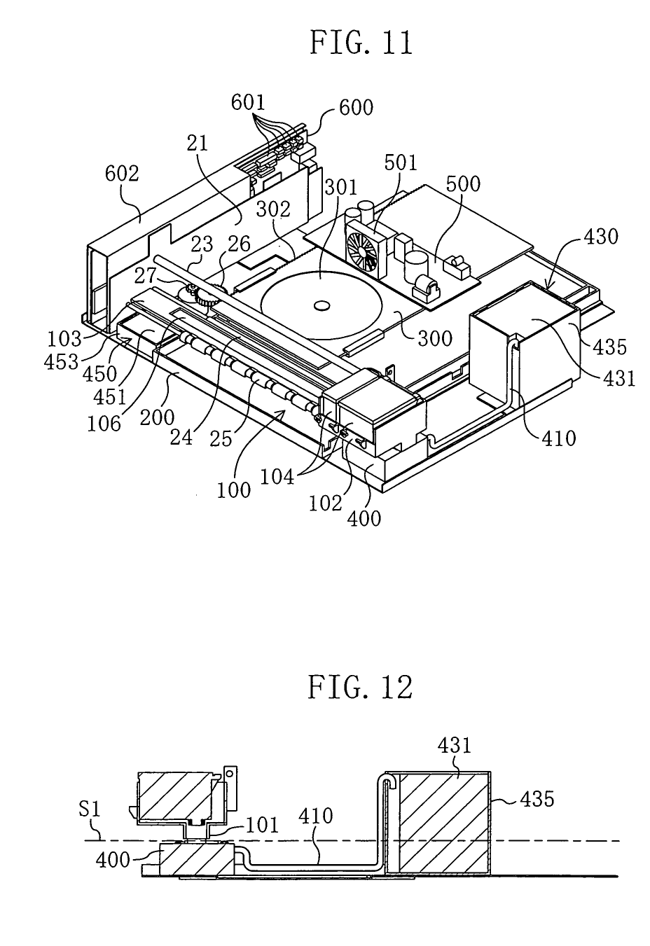

For example, as shown in FIGS. 11 and 12, by attaching the one end of the tube 410 to an upper end part of the ink container 435, the tube 410 may be provided so as to supply the ink after purge to the upper end part of the ink container 435. This allows the ink to be absorbed from the upper part of the sponge 431 inside of the ink container 435, so that there is less possibility that the ink leaks from the bottom part of the ink container 435.

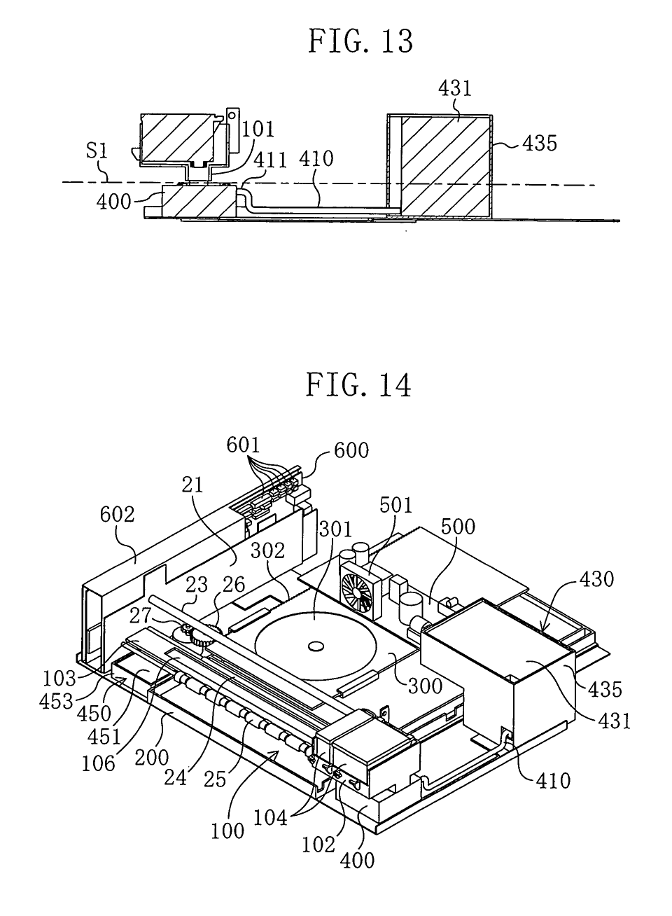

Furthermore, as shown in FIG. 13, the tube 410 may be structured to supply the ink to the lower end part inside of the ink container 435 by connecting the tube 410 to the lower end part of the ink container 435. In this case, the whole tube 410 excluding the connection part 411 between the tube 410 and the purge unit 400 is preferably at a lower level than the connection part 411. According to this connection aspect, since the ink is conveyed only downward, conveying load of the purge unit 400 is reduced. Accordingly, the conveying of the ink from the purge unit 400 to the first ink collector 430 is easy. Furthermore, in the case where absorbency of the absorbing body inside of the ink container 435 is large, the back flow of the ink from the first ink collector 430 hardly occurs. Therefore, the above-mentioned connection aspect is particularly effective in the case where the absorbency of the absorbing body is large.

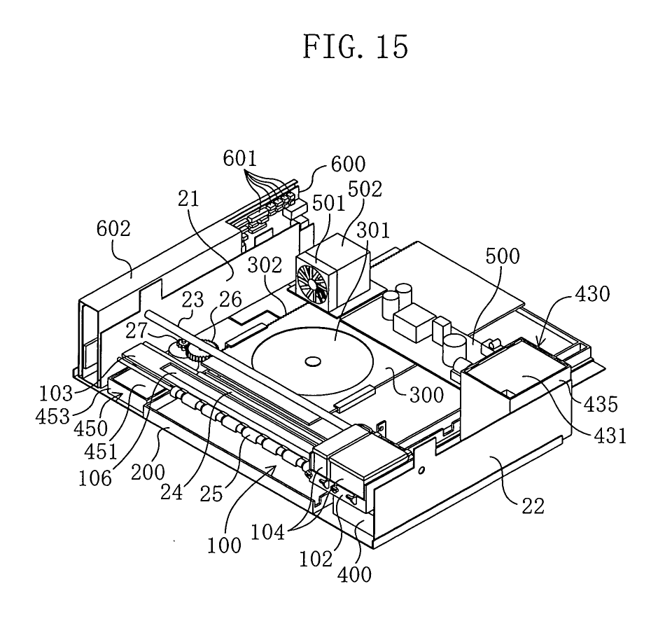

Furthermore, in the present embodiment, although when drying the disk by the fan 501, the power supply substrate 600 is used as a heat source, a new heat source can obviously be provided apart from the power supply substrate 600. For example, as shown in FIG. 15, a heater 502 may be provided in the vicinity of the fan 501. The type of the heater 502 is not limited. However, in this case, it is advantageous that a fan cooling the power supply substrate 600 is provided separately.

### Embodiment 2

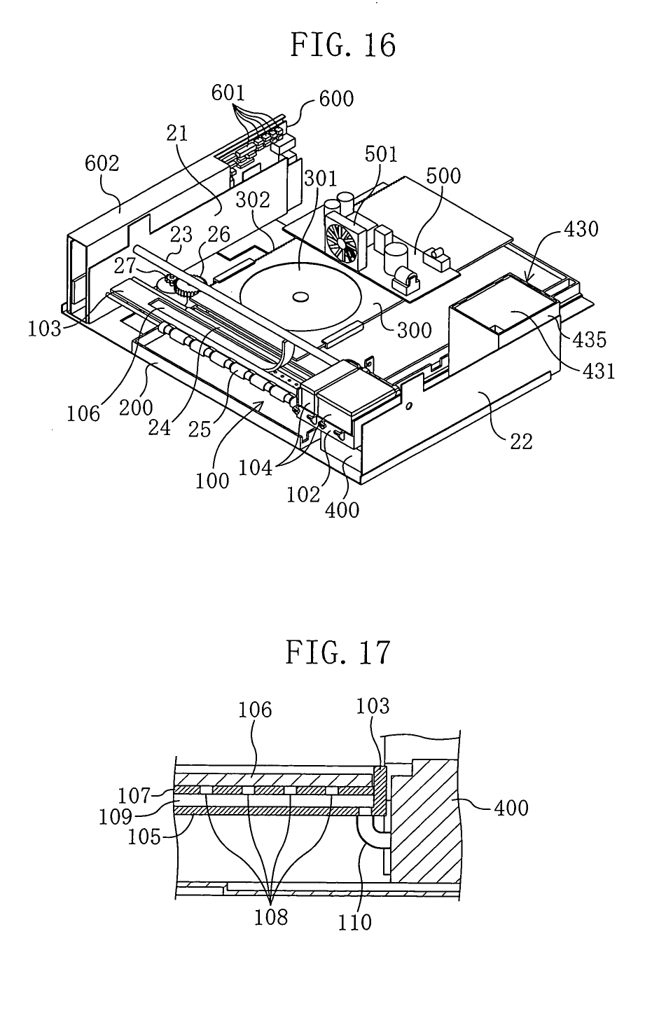

FIG. 16 shows Embodiment 2 of the present invention (the same parts as shown in FIG. 3 are indicated by the same reference numerals and signs and their detailed description is omitted), the second ink collector 450 in Embodiment 1 is omitted, the ink absorbed in the sponge 106 on the platen 103 is sucked and removed by the purge unit 400, and this sucked and removed ink is collected in the ink container 435 of first ink collector 430 which is identical with the ink container for the purged ink of the recording head 101.

More specifically, in this Embodiment 2, as shown in FIG. 17, an intermediate plate 107 extending in the casing lateral direction is provided inside of the depression 105 of the platen 103 and in this intermediate plate 107, a plurality of ink passing holes 108 are formed at predetermined intervals in the casing lateral direction. A space 109 collecting the ink is partitioned and formed between this intermediate plate 107 and a bottom surface of the depression 105, and on an upper surface of the intermediate plate 107, the sponge 106 described in Embodiment 1 is set. Accordingly, the ink absorbed in the sponge 106 is introduced to the inside of the space 109 through the respective ink passing holes 108. Then, a tube 110 as an ink flow path communicating the space 109 and the purge unit 400 is connected in an end part on the casing right side of the platen 103, and the ink introduced to the inside of the space 109 is sucked and removed in the purge unit 400 through the tube 110 during operation of the purge unit 400 (at purge time). Furthermore, in the purge, since a sucking force of the purge unit 400 also acts on the sponge 106, the ink absorbed in the sponge 106 is easily introduced to the inside of the space 109 from the respective ink passing holes 108. The ink sucked and removed in the purge unit 400 from the sponge 106 is collected in the ink container 435 of the first ink collector 430 via the tube 410.

Accordingly, according to the present embodiment, since the ink absorbed in the sponge 106 of the platen 103 is sucked and removed by the purge unit 400, a large amount of ink is prevented from being retained in the sponge 106. Therefore, the leakage of the ink from the platen 103 hardly occurs, and even if the printer 1 is inclined, the ink hardly leaks out.

Furthermore, according to the present embodiment, since the second ink collector 450 is not required, miniaturization of the device can be accomplished.

In the present embodiment, although the second ink collector 450 in Embodiment 1 is omitted, the second ink collector 450 can obviously be provided. More specifically, the ink absorbed in the sponge 106 of the platen 103 can also be collected by both the purge unit 400 (that is, the first ink collector 430) and the second ink collector 450.

### Embodiment 3

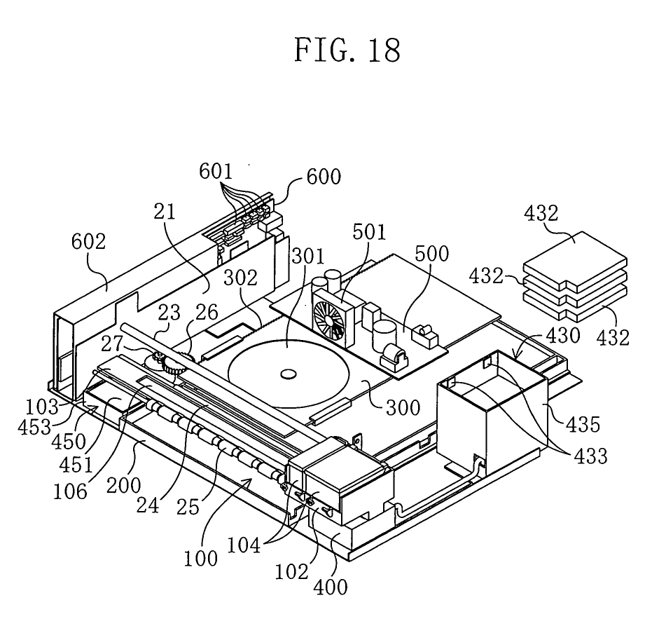

FIG. 18 shows Embodiment 3 of the present invention, in which detecting means for detecting a collected amount of ink of the first ink collector 430 is provided and the absorbing body of the first ink collector 430 is replaceable. In the present embodiment, the second ink collector 450 similar to that of the above-mentioned Embodiment 1 is provided.

More specifically, in this Embodiment 3, the absorbing body of the first ink collector 430 is made of a plurality of sponge sheets 432 (sheet absorbers) and these plurality of sponge sheets 432 are layered inside of the ink container 435.

In an upper part of a side wall of the ink container 435, a pair of electrodes 433 are attached. This pair of electrodes 433 is provided with a voltage applying device applying voltage between the electrodes 433 and a resistance detecting device detecting electric resistance between the electrodes 433, whose illustrations are omitted. The pair of electrodes 433, voltage applying device and resistance detecting device make up the detecting means for detecting the amount of ink inside of the ink container 435. That is, this detecting means is constructed by an electric sensor having the pair of the electrodes 433 and detecting the amount of ink based on the electric resistance between the pair of electrodes 433.

The principle of detecting the amount of ink of this sensor is described. Since the sponge sheets 432 are made of a nonconductive material, when the sponge sheets 432 in contact with the electrodes 433 do not contain the ink, a current does not flow between the electrodes 433. On the other hand, when the sponge sheets 432 in contact with the electrodes 433 absorb the ink, a current according to the absorbed amount of ink flows between the electrodes 433. Accordingly, the absorbed amount of ink by the sponge sheets 432 can be detected based on the current flowing between the electrodes 433. In other words, how much of the ink is absorbed can be estimated based on a resistance value between the electrodes 433. That is, by the resistance value between the electrodes 433, a collected amount of ink in the first ink collector 430 can be detected.

In the present embodiment, when the resistance value between the electrodes 433 falls below a predetermined value, a predetermined notice indicating that the first ink collector 430 is filled is given. This notice method is not particularly limited, and for example, a lamp for notice may be provided in the front surface of the casing 10 and the lamp may light when the resistance value falls below the predetermined value. Also, this may be displayed in external equipment (for example, a television, a personal computer or the like) connected via the external connection terminals 16 to 19. Furthermore, the notice method is not limited to the display, but the notice can be given by using a sound.

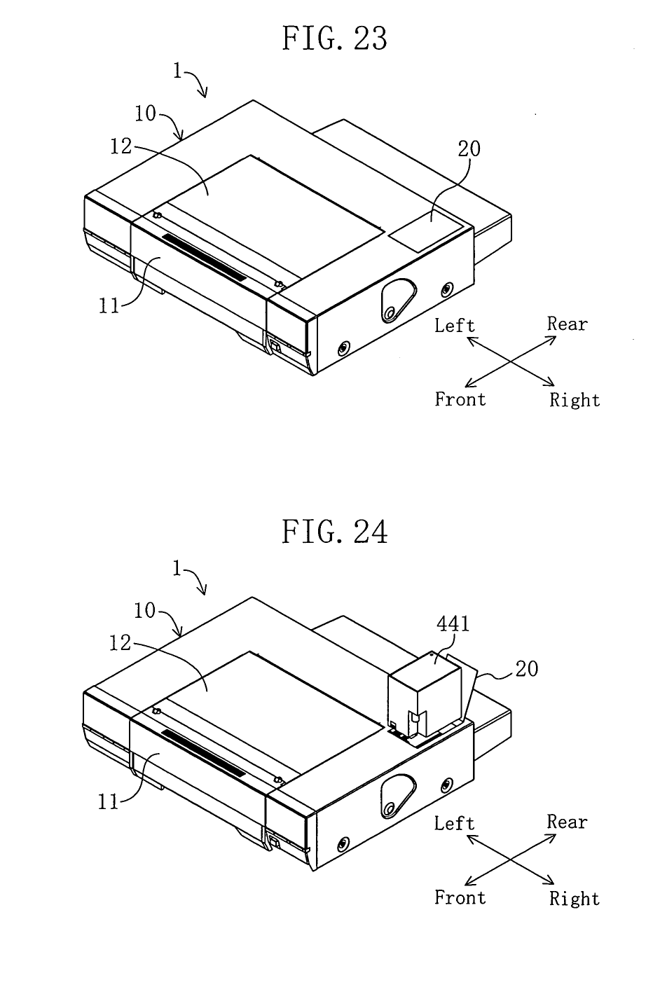

By the above-mentioned notice, the user recognizes that the collected ink has filled the first ink collector 430, and replaces the sponge sheets 432 absorbing the ink with new ones. This can reproduce the first ink collector 430. This replacement of the sponge sheets 432 may be performed through the opening covered with the upper lid 12 in the upper surface of the casing 10 by broadening the opening up to the part above the ink container 435, or by providing an entrance for replacement as explained in after-mentioned Embodiment 4 in a part of the upper surface of the casing 10 corresponding to the ink container 435 (refer to FIGS. 23 and 24), the replacement may be performed through the entrance.

By repeating the replacement of the sponge sheets 432, the first ink collector 430 can be used semipermanently. Thus, on the premise of the replacement of the sponge sheets 432, the amount of the ink collected in the first ink collector 430 itself may be small. As a result, the first ink collector 430 can be miniaturized and further miniaturization of the device can be accomplished.

Accordingly, according to the present embodiment, the user can easily and reliably recognize by the lamp for notice or the like that the collected ink has filled the first ink collector 430. Therefore, the user can easily recognize the time when the replacement of the sponge sheets 432 is required, and the replacing work can be performed at an appropriate time.

The absorbing body of the first ink collector 430 is not limited to the sponge sheets 432, but may be a plurality of block-shaped sponges. Alternatively, similar to Embodiment 1, it may be a one size smaller cubic or rectangular parallelepiped sponge than the ink container 435. Alternatively, it may be a grained absorbing body or the like. However, when it is made of a sheet absorber, the handlability of the absorbing body is increased.

In the present embodiment, although the detecting means for detecting the absorbed amount of ink is the electric sensor using the electrodes 433, it is not limited to the electric sensor, but another means can obviously be used. For example, the number of cleanings of the recording head 101, the number of replacements of the ink tank 104 or the like may be measured and the collected amount of ink in the first ink collector 430 may be estimated from the number of times. The detecting means of the present invention is not limited to a direct detection but includes means for performing indirect detection by such estimation.

### Embodiment 4

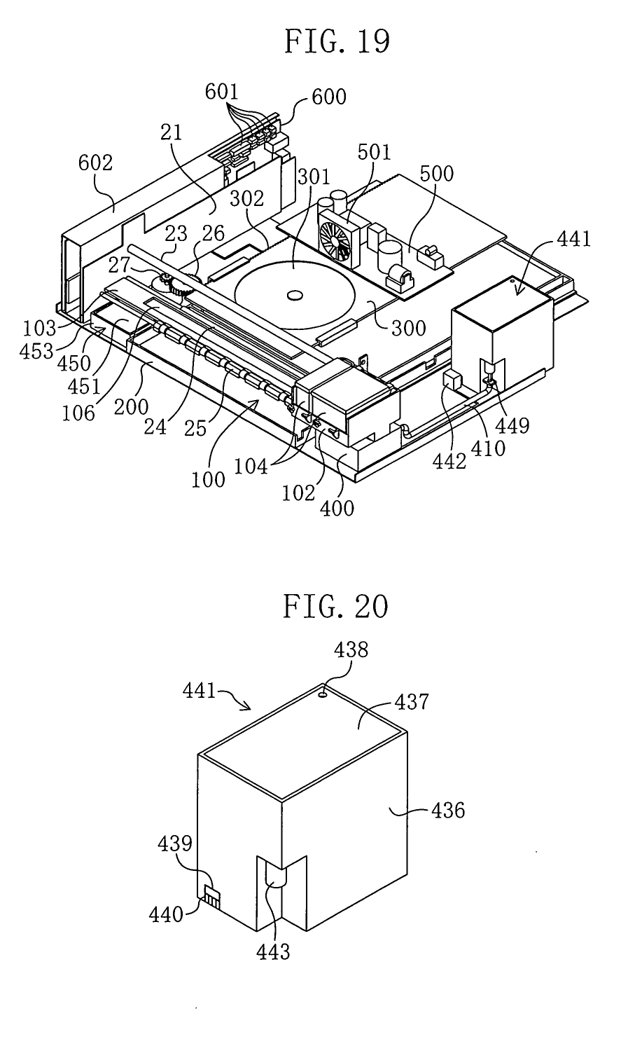

FIG. 19 shows Embodiment 4 of the present invention, in which the first ink collector is structured to be of a cartridge type which is easily replaced. In the present embodiment, the second ink collector 450 similar to that of the above-mentioned Embodiment 1 is also provided.

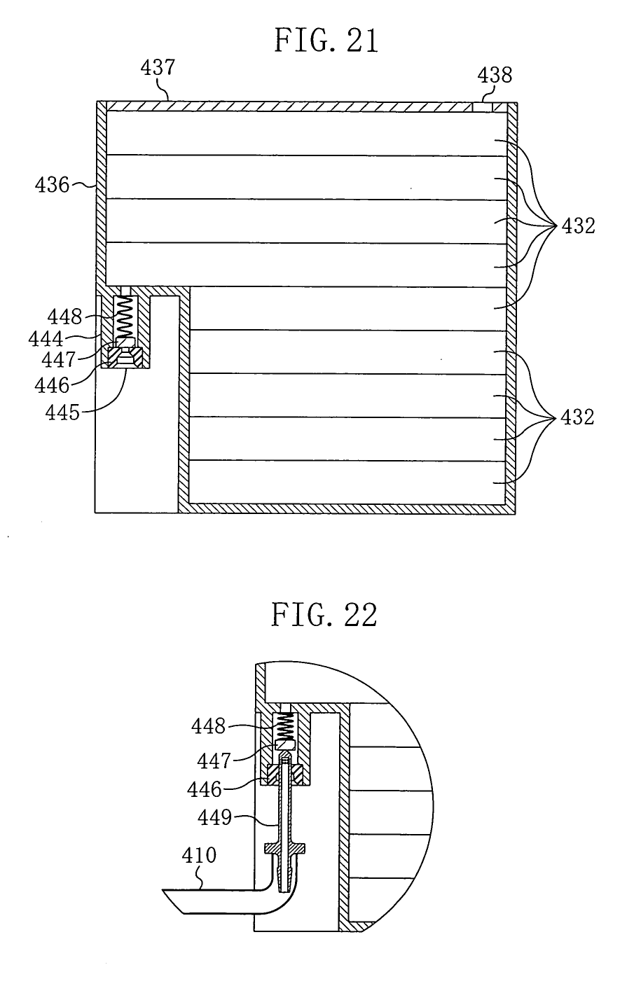

More specifically, in this Embodiment 4, as shown in FIGS. 20 and 21, the first ink collector is constructed by an absorber cartridge 441 provided with an ink container 436, a cover 437 covering an opening on the upper side of the ink container 436, and the plurality of sponge sheets 432 housed in the ink container 436. In the cover 437, an atmospheric air communicating hole 438 is formed. This atmospheric air communicating hole 438 is a leak-off hole for allowing air contained in the ink delivered from the purge unit 400 to escape. Thus, by providing the atmospheric air communicating hole 438 in the cover 437, the ink collection from the purge unit 400 to the absorber cartridge 441 is made smooth. Although in view of preventing ink leakage, it is preferable that the atmospheric air communicating hole 438 is provided on the upper side of the absorber cartridge 441, it is not necessarily required to be provided in the cover 437 but it may be provided in the ink container 436 itself.

In a lower part of a casing front side surface of the ink container 436, a memory 439 (storage means) with a terminal 440 attached is provided, as shown in FIG. 20. This terminal 440 is a terminal connected to a body side terminal 442 attached to the casing 10 (refer to FIG. 19). When the absorber cartridge 441 is mounted, the terminal 440 and the body side terminal 442 are in contact with each other, thereby enabling signal transmission. This enables reading and writing of the data in the memory 439. This memory 439 is intended to store the amount of waste ink produced every cleaning or ink replacement, that is, the collected amount of ink collected in the ink container 436. This information on the amount of collected ink is written in the memory 439 through the body side terminal 442 and the terminal 440. When the amount of collected ink stored in the memory 439 exceeds the predetermined amount, the predetermined notice to promote the replacement of the absorber cartridge 441 is given to the notice means (the indication light or the like) provided on the surface of the casing 10.

At a corner part in a lower part on the casing light front side of the ink container 436, a recessed part is formed, and in an upper surface inside of this recessed part, an ink introducing mechanism 443 is provided. This ink introducing mechanism 443, as shown in FIG. 21, is constructed by an introducing tube 444 extending downward from the upper surface of the recessed part, a rubber lid 446 fitted into an ink injection port 445 which is a lower end part of this introducing tube 444, a valve 447 covering an upper opening of an introducing port formed so as to penetrate a central part of this rubber lid 446 in the vertical direction, and a spring 448 energizing this valve 447 toward the rubber lid 446. The valve 447 is energized toward the rubber lid 446 by the spring 448 in a state in which no force is applied from the outside, by which the upper opening of the introducing port of the rubber lid 446 becomes in a state closed by the valve 447. Instead of the rubber lid 446, a lid formed of a material other than rubber can obviously be used. For example, a lid formed of plastic may be used. The structure of the ink introducing mechanism 443 is not limited to the above-mentioned structure.

In addition, as shown in FIG. 22, an ink discharging needle 449 is attached to a tip end of the tube 410 extending from the purge unit 400. This ink discharging needle 449 is fixed upward and inserted into the ink introducing mechanism 443 with the mounting of the absorber cartridge 441. When the ink discharging needle 449 is inserted into the ink introducing mechanism 443, the valve 447 is pushed up by the ink discharging needle 449. As a result, the introducing port of the rubber lid 446 is opened and the purge unit 400 and the absorber cartridge 441 are communicated through the tube 410 and the ink discharging needle 449. Accordingly, a state in which the collection of the ink from the purge unit 400 to the absorber cartridge 441 is enabled is attained.

When removing the absorber cartridge 441, the valve 447 shuts the introducing port of the rubber lid 446, so that leakage of the ink from the absorber cartridge 441 is prevented.

In the upper surface of the casing 10, the entrance for taking out and setting the absorber cartridge 441 with respect to the inside of the casing 10 and a lid 20 opening and closing this entrance are provided (refer to FIGS. 23 and 24). In the present embodiment, by inserting the absorber cartridge 441 into the casing 10 downward through the entrance in a state in which the lid 20 is opened, the absorber cartridge 441 can be easily mounted. Furthermore, by pulling the absorber cartridge 441 upward in the state in which the lid 20 is opened, the absorber cartridge 441 can be easily removed. Accordingly, the absorber cartridge 441 can be easily replaced.

Accordingly, in the present embodiment, since the first ink collector is constructed by the replaceable absorber cartridge 441, the first ink collector can be miniaturized. Furthermore, as compared with the case where only the absorbing body is replaced, handlability is increased.

Furthermore, in the above-mentioned embodiment, since the memory 439 is provided in the absorber cartridge 441 so that the absorber cartridge 441 itself has the information on the amount of collected ink of the absorber cartridge 441, even if the absorber cartridge 441 is attached or removed as necessary, the amount of collected ink of the absorber cartridge 441 can be constantly grasped.

However, the information on the amount of collected ink of the absorber cartridge 441 can obviously be stored in a place other than the absorber cartridge 441. For example, an identification number of the absorber cartridge 441 and the amount of collected ink of the absorber cartridge 441 may be stored in the control substrate 600, an external personal computer or the like.

Furthermore, the information on the amount of collected ink is not necessarily required to be stored but the detecting means for detecting the amount of collected ink may be provided in the absorber cartridge 441. For example, as in Embodiment 3, the detecting means for detecting the amount of collected ink based on the electric resistance value of the absorbing body may be provided. Furthermore, the detecting means for detecting the amount of collected ink based on the number of cleanings of the recording head 101 or the number of replacements of the ink tank 104 may be provided.

Furthermore, when replacing the absorber cartridge 441, the whole cartridge 441 may be replaced with a new one but only the sponge sheets 432 inside of the ink container 436 may be replaced by removing the cover 437. That is, the ink container 436 and the cover 437 may be reused.

The embodiments of the present invention are not limited to the above-mentioned embodiments, but other embodiments obviously are possible. Furthermore, any combination of the above-mentioned embodiments is possible.

### INDUSTRIAL APPLICABILITY

The present invention is useful for an ink-jet recording device provided with a substantially rectangular parallelepiped casing whose vertical length is shorter than lateral and anteroposterior lengths thereof, that is, a thin casing.

1. An ink-jet recording device comprising:
a substantially rectangular parallelepiped casing whose vertical length is shorter than lateral and anteroposterior lengths thereof;
an ink-jet recording head provided inside of the casing;
a tray which is arranged under the recording head inside of the casing and supports a recording medium on which recording is performed by the recording head;
a moving mechanism moving the tray in the casing anteroposterior direction so that the tray passes through a position under the recording head; and
a power supply substrate arranged above the tray inside of the casing.

2. The ink-jet recording device of claim 1 further comprising:
a supply cassette which is arranged under the tray inside of the casing and houses a recording medium different from the recording medium supported by the tray; and
a conveying mechanism conveying the recording medium housed in the supply cassette to a recording position where the recording is performed by the recording head.

3. The inkjet recording device of claim 1 further comprising:
a carriage shaft extending in a casing lateral direction inside of the casing;
a chassis supporting both ends of the carriage shaft;
a carriage which holds the recording head, reciprocates along the carriage shaft in the casing lateral direction, and has a home position at any one of the ends of the carriage shaft; and
a control substrate provided vertically in a direction perpendicular to the carriage shaft at a position outside of the chassis on the opposite side of the home position in the casing lateral direction inside of the casing.

4. The ink-jet recording device of claim 1, wherein:
a protruded part which is protruded rearward is formed in a back surface of the casing; and
external connection terminals are provided in a part other than the protruded part in the back surface of the casing.

5. The ink-jet recording device of claim 3, wherein:
a protruded part which is protruded rearward is formed in a back surface of the casing; and
external connection terminal are provided in a part other than the protruded part in the back surface of the casing.

6. The ink-jet recording device of claim 1 further comprising a fan sending air to the recording medium after recording onto the recording medium supported by the tray.

7. The ink-jet recording device of claim 6 further comprising a heat source heating the air sent by the fan.

8. The ink-jet recording device of claim 6, wherein the fan is constructed by a cooling fan of the power supply substrate.

9. The ink-jet recording device of claim 3, wherein:
the control substrate has a plurality of external connection terminals in line vertically; and
in the casing, an opening for connection to the external connection terminals is formed.

10. The inkjet recording device of claim 9, wherein:
the plurality of external connection terminals are provided in line vertically in an end part on the casing front side of the control substrate and an end part on the casing rear side thereof, respectively; and
in the front surface and the back surface of the casing, openings for connection to the external connection terminals in the end part on the casing front side of the control substrate and in the end part on the casing rear side thereof are formed, respectively.

11. The ink-jet recording device of claim 3, wherein the control substrate has a plurality of internal connection terminals arranged in an upper part of the control substrate.

12. The ink-jet recording device of claim 11, wherein the internal connection terminals are provided so as to be oriented inward in the casing lateral direction in an inner surface in the casing lateral direction of the control substrate.

13. The ink-jet recording device of claim 4, wherein:
the supply cassette is a cassette whose length in the casing anteroposterior direction is longer than an anteroposterior length of a casing side surface, and which extends rearward beyond a rear end of the casing side surface; and
the protruded part of the casing covers the rear end part of the supply cassette extending rearward beyond the rear end of the casing side surface.

14. An ink-jet recording device comprising:
a substantially rectangular parallelepiped casing whose vertical length is shorter than lateral and anteroposterior lengths thereof;
a carriage shaft extending in the casing lateral direction inside of the casing;
a chassis supporting both ends of the carriage shaft;
a carriage which reciprocates along the carriage shaft in the casing lateral direction and has a home position at any one of the ends of the carriage shaft;
an inkjet recording head attached to the carriage; and
a control substrate provided vertically in a direction perpendicular to the carriage shaft at a position outside of the chassis on the opposite side of the home position in the casing lateral direction inside of the casing.

15. The ink-jet recording device of claim 14, wherein:
a protruded part which is protruded rearward is formed in a back surface of the casing; and
external connection terminals are provided in a part other than the protruded part in the back surface of the casing.

16. The ink-jet recording device of claim 14, wherein:
the control substrate has a plurality of external connection terminals in line vertically; and
in the casing, an opening for connection to the external connection terminals is formed.

17. The ink-jet recording device of claim 16, wherein:
the plurality of external connection terminals are provided in line vertically in an end part on the casing front side of the control substrate and an end part on the casing rear side thereof, respectively; and
in the front surface and the back surface of the casing, openings for connection to the external connection terminals in the end part on the casing front side of the control substrate and in the end part on the casing rear side thereof are formed, respectively.

18. The ink-jet recording device of claim 14, wherein the control substrate has a plurality of internal connection terminals arranged in an upper part of the control substrate.

19. The inkjet recording device of claim 18, wherein the internal connection terminals are provided so as to be oriented inward in the casing lateral direction in an inner surface in the casing lateral direction of the control substrate.

20. The ink-jet recording device of claim 15, wherein:
the supply cassette is a cassette whose length in the casing anteroposterior direction is longer than an anteroposterior length of a casing side surface, and which extends rearward beyond a rear end of the casing side surface; and
the protruded part of the casing covers the rear end part of the supply cassette extending rearward beyond the rear end of the casing side surface.

21. An ink-jet recording device comprising:
a substantially rectangular parallelepiped casing whose vertical length is shorter than lateral and anteroposterior lengths thereof;
an ink-jet recording head provided inside of the casing;
a supply cassette which is arranged under the recording head inside of the casing and houses a recording medium on which recording is performed by the recording head; and
a conveying mechanism conveying the recording medium housed in the supply cassette to a recording position where the recording is performed by the recording head,
wherein a protruded part which is protruded rearward is formed in a back surface of the casing; and
external connection terminals are provided in a part other than the protruded part in the back surface of the casing.

22. The ink-jet recording device of claim 21, wherein:
the supply cassette is a cassette whose length in the casing anteroposterior direction is longer than an anteroposterior length of a casing side surface, and which extends rearward beyond a rear end of the casing side surface; and
the protruded part of the casing covers the rear end part of the supply cassette extending rearward beyond the rear end of the casing side surface.

23. An ink-jet recording device comprising:
a substantially rectangular parallelepiped casing whose vertical length is shorter than lateral and anteroposterior lengths thereof;
a carriage shaft extending in the casing lateral direction inside of the casing;
a carriage which reciprocates along the carriage shaft in the casing lateral direction;
an ink-jet recording head attached to the carriage;
a conveying mechanism conveying a recording medium in a direction perpendicular to the carriage shaft during recording operation onto the recording medium by the recording head to lead the recording medium to a recording position where the recording is performed by the recording head;
a purge unit which is provided on one end side of the carriage shaft and purges ink of the recording head; and
a first ink collector which has an ink container set on the lateral side of a conveying route of the recording medium inside of the casing and collects the ink after purge of the purge unit in the ink container.

24. The ink-jet recording device of claim 23, wherein the ink container of the first ink collector extends from a lower position than a recording surface of the recording medium located at the recording position to a higher position than the recording surface.

25. The ink-jet recording device of claim 23 further comprising:
a platen which is opposed to the recording head and supports the recording medium located at the recording position;
an absorbing body which is provided in the platen and absorbs excessive ink not landed on the recording medium out of ink discharged from the recording head; and
a second ink collector which has an ink container and collects the ink absorbed in the absorbing body inside of the ink container.

26. The ink-jet recording device of claim 25, wherein both the ink containers of the first and second ink collectors are arranged on one side and the other side in the casing lateral direction, respectively.

27. The ink-jet recording device of claim 23 further comprising:
a platen which is opposed to the recording head and supports the recording medium located at the recording position;
an absorbing body which is provided in the platen and absorbs excessive ink not landed on the recording medium out of ink discharged from the recording head; and
an ink flow path connecting the platen and the purge unit,
wherein the ink absorbed in the absorbing body is sucked and removed in the purge unit through the ink flow path.

28. The ink-jet recording device of claim 23, wherein an absorbing body absorbing the ink is housed inside of the ink container of the first ink collector.

29. The ink-jet recording device of claim 28 wherein the absorbing body inside of the ink container of the first ink collector is housed replaceably with respect to the ink container.

30. The ink-jet recording device of claim 28, wherein the absorbing body inside of the ink container of the first ink collector is constructed by a plurality of sheet absorbers layered in the ink container.

31. The ink-jet recording device of claim 28 further comprising an ink flow path leading the ink after purge of the purge unit to an upper end part of the ink container of the first ink collector.

32. The ink-jet recording device of claim 28 further comprising an ink flow path leading the ink after purge of the purge unit to a lower end part of the ink container of the first ink collector.

33. The inkjet recording device of claim 28 further comprising an ink flow path leading the ink after purge of the purge unit to an intermediate part in the vertical direction of the ink container of the first ink collector.

34. The ink-jet recording device of claim 28, wherein:
the ink container of the first ink collector extends from a lower position than a recording surface of the recording medium located at the recording position to a higher position than the recording surface;
the ink-jet recording device further comprises an ink flow path leading the ink after purge of the purge unit to the ink container of the first ink collector; and
a connection point of the ink flow path with respect to the ink container of the first ink collector is located between the recording surface of the recording medium located at the recording position and a lowest part of the ink container.

35. The ink-jet recording device of claim 28 further comprising an ink flow path leading the ink after purge of the purge unit to the ink container of the first ink collector,
wherein a connection point of the ink flow path with respect to the ink container of the first ink collector is located at a lower level than a connection point of the ink flow path with respect to the purge unit.

36. The ink-jet recording device of claim 23 wherein the first ink collector is constructed detachably with respect to the casing.

37. The inkjet recording device of claim 36, wherein an entrance for taking out and setting the first ink collector with respect to the inside of the casing is formed in an upper surface of the casing.

38. The ink-jet recording device of claim 37, wherein a lid opening and closing the entrance is provided in the upper surface of the casing.

39. The ink-jet recording device of claim 23, wherein the first ink collector has detecting means for detecting the amount of ink inside of the ink container of the first ink collector.

40. The ink-jet recording device of claim 39, wherein the detecting means is constructed by an electric sensor having a pair of electrodes and detecting the amount of ink based on electric resistance between the pair of electrodes.

41. The ink-jet recording device of claim 23, wherein the first ink collector has storage means for storing the amount of ink collected in the ink container of the first ink collector.

42. The ink-jet recording device of claim 23, wherein the ink container of the first ink collector is arranged on the casing rear side of the purge unit.
